(19) United States
(12) Patent Application Publication
(10) Pub. No.: US 2009/0117888 A1
(43) Pub. Date: May 7, 2009

(54) WIRELESS DEVICE HAVING CONFIGURABLE MODES

(75) Inventors: Kirk S. Taylor, San Diego, CA (US); Guilherme Luiz Karnas Hoefel, San Diego, CA (US); Liren Chen, San Diego, CA (US); Jack Steenstra, San Diego, CA (US); Lucian Suta, Mission Viejo, CA (US); Yang Zhang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/936,350

(22) Filed: Nov. 7, 2007

(51) Int. Cl. H04M 3/00; H04M 1/00

(52) U.S. Cl. 455/418; 455/550.1

(57) ABSTRACT

A wireless device having user defined configurable modes includes a memory have at least one configuration segment containing configuration information relating to at least one application or mode. The user enters the user defined configuration that causes a control processor to configure the wireless device based on the configuration information.

### CLAIM OF PRIORITY UNDER 35 U.S.C. §119

None.

### CLAIM OF PRIORITY UNDER 35 U.S.C. §120

None.

### REFERENCE TO CO-PENDING APPLICATIONS FOR PATENT

None.

### BACKGROUND

1. Field

The present relates to wireless device having user configurable modes and, more specifically to cellular telephones being reconfigurable based on user input and location.

2. Background

Wireless devices, and particularly cellular telephones, are becoming ubiquitous in society. These devices allow consumers to be accessible in almost all locations in almost all times of the day. Additionally, today's wireless devices have more computer power than ever before. Wireless devices allow verbal communication, short message service, text messaging, electronic mail, internet applications, electronic games, video and audio streaming, and the like.

While access to the various applications is beneficial, it creates numerous difficulties in numerous situations. Some of the difficulties relate in particular to safety and health concerns. Other difficulties relate in particular to common courtesy. Still other difficulties relate to the ability to use the wireless device in particular environments.

Safety concerns can arise in numerous situations. One potential safety issue may be accessing email accounts while driving, which would provide a potentially unsafe or dangerous condition. Another safety issue arises when, for example, the high radio frequency transmissions of conventional cellular telephone transmissions interfere with there electronic equipment, such as, for example, medical equipment or aviation equipment.

Common courtesy issues generally arise in public settings. It is generally accepted that talking on a cellular telephone is discourteous in a theater or the like. Other discourteous wireless device usages may include using the devices during meetings, in crowded waiting rooms, or the like.

Still other situations are simply difficult environments for the wireless device usage. For example, it may be difficult to use a cellular telephone in a machine shop where loud noise makes it difficult to communicate. A gym or weight room may provide a similar difficult use environment. Alternatively, a low light or visibility area may make use of any-wireless device difficult, such as, for example, a photograph dark room or the like.

Thus, it would be desirous to provide a wireless device that has configurable modes of operation to address the above and other needs of the industry.

### SUMMARY

Embodiments disclosed herein address the above stated needs by providing a wireless device. The wireless device includes a user interface, a control processor, transmit and receive circuitry coupled to the control processor, and a memory, the memory comprises at least a configuration segment that contains at least one user defined setting containing configuration information for the wireless device, such that a user uses the user interface to transmit the at least one user defined setting to the control processor, the control processor uses the at least one user defined setting to access the configuration segment and configure the wireless device using the configuration information contained in the user defined setting.

Other aspects of the technology described herein include methods for recording a user defined setting in a wireless device. The method includes launching a configuration entering program on the wireless device to allow a user to define a setting and enter configuration information. The user defined setting and configuration information.

Still other aspects of the technology described herein include methods of configuring a wireless device to user defined settings. The methods include launching a configuration application at the wireless device. The user defined setting to be entered is identified to retrieve the configuration information relating to at least one application or at least one mode of the wireless device from memory. The wireless device is configured based on the configuration information retrieved relating to the at least one application or the at least one mode.

To facilitate operation, the above and other aspects of the technology described herein may be incorporated into operation such that a single key stroke or operation implements the configuration change. Such a operation may be similar to a hotkey or speed dial.

### BRIEF DESCRIPTION OF THE DRAWINGS

FIG. 1 is a block diagram illustration of a wireless communication system of an exemplary embodiment of the disclosure;

FIG. 2 is a block diagram illustration of a wireless device of an exemplary embodiment;

FIG. 3 is a diagrammatic illustration of a memory structure of an exemplary embodiment;

FIG. 4 is a flow chart diagram illustration of operational steps of configuring a wireless device of an exemplary embodiment;

FIG. 5 is a flow chart diagram illustration of operational steps of configuring a wireless device of an exemplary embodiment;

FIG. 6 is a flow chart diagram illustration of operational steps of entering a setting configured according to an exemplary embodiment;

FIG. 7 is a flow chart diagram illustration of operational steps of entering a setting-configured according to an exemplary embodiment; and

FIG. 8 is a block diagram illustration of an area having a predefined setting configuration of an exemplary embodiment.

### DETAILED DESCRIPTION

The technology of the present application will now be described with specific reference to the figures. For convenience, the technology will be explained with reference to a cellular telephone. However, on reading the disclosure, one of ordinary skill in the art will now recognize that the technology explained herein could be used in numerous wireless or mobile devices including, for example, cellular telephones, pagers, laptop computers, desktop computers, handheld computers, PDAs, mobile electronic mail devices, electronic games, MPEG players, MP-3 players, personal navigation units, and the like. Thus, in this written description, reference to a cellular telephone should be construed broadly to encompass other wireless or other mobile devices. Moreover, technology of the present application is described with reference to specific exemplary embodiments. The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

The word “network” is used herein to mean one or more conventional or proprietary networks using an appropriate network data transmission protocol. Examples of such networks include, PSTN, LAN, WAN, WiFi, WiMax, Internet, World Wide Web, Ethernet, other wireless networks, and the like.

The words “wireless device,” “mobile device,” and “cellular telephone” are generally used interchangeably in the written description and mean one or more conventional or proprietary wireless devices including, cellular telephones, pagers, two-way radios, wireless computers (laptops, desktops, and handhelds), PDAs, electronic games, MPEG players, MP-3 players, and the like.

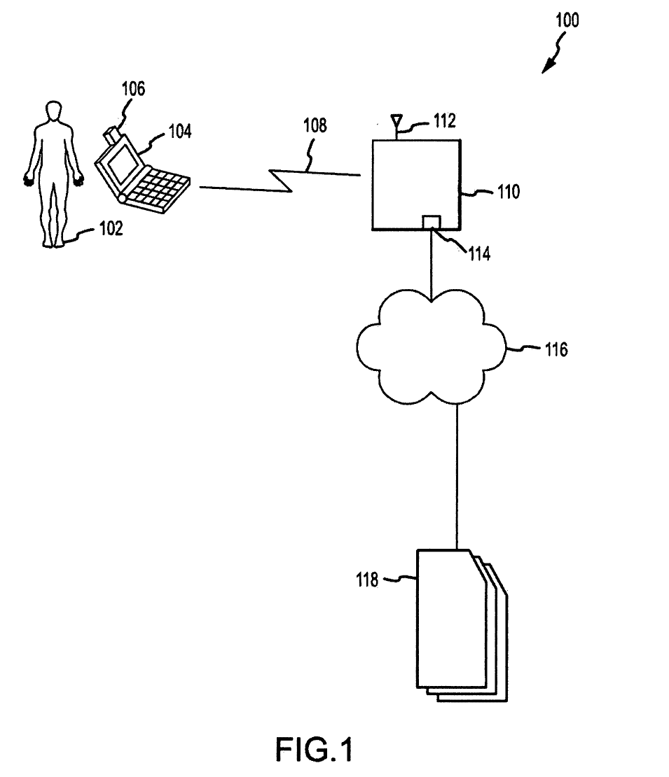

Referring first to FIG. 1, a cellular communication system 100 using technology of the present invention is illustrated. In this exemplary cellular communication system 100, a user 102 is provided with a cellular telephone or wireless device 104. As mentioned above, wireless device 104 may be referred to herein as cellular telephone 104 (which is one example of a wireless device) or mobile device 104 generically. Wireless device 104 would include at least one radio frequency antenna 106, but may have multiple antennas for different applications. Frequently, wireless device 104 transmits and receives radio frequency signals over multiple operational frequencies that may require either multiple antennas or multiple band antennas that operate over the necessary frequencies. While generally described as a cellular telephone due to the ubiquitous nature of cellular telephones, as described above, wireless device 104 may comprise any number of different types of wireless or mobile devices.

Wireless device 104 is connected via a wireless communication data link 108 to a base station 110. Base station 110 has an antenna 112. Antenna 106 and base station antenna 112 can transmit and receive respective radio frequency signals to allow data transfer between wireless device 104 and base station 110. Base station 110 may have a network interface 114 such that it is interconnected to a network 116. Network 116 may be several networks, but network 116 will be described as a single network for convenience. Network 116 typically is connected to servers 118 and/or service centers 120 as necessary.

Cellular communication system 100 is shown with a single wireless device 104 connected to a single base station 110. It is envisioned, however, that cellular communication system 100 would support multiple wireless devices 104, multiple base station 110 and multiple networks as a matter of design choice. In these instances, it may be beneficial to incorporate security measures in the system and assign unique identifiers to the wireless devices.

Wireless device 104 communicates with base station 110 using a conventional protocol, such as CDMA or the like, although any analog or digital protocol is acceptable. Moreover, while described using, a cellular network for communication and data transfer between wireless device 104 and base station 110, other wireless or wired networks are possible.

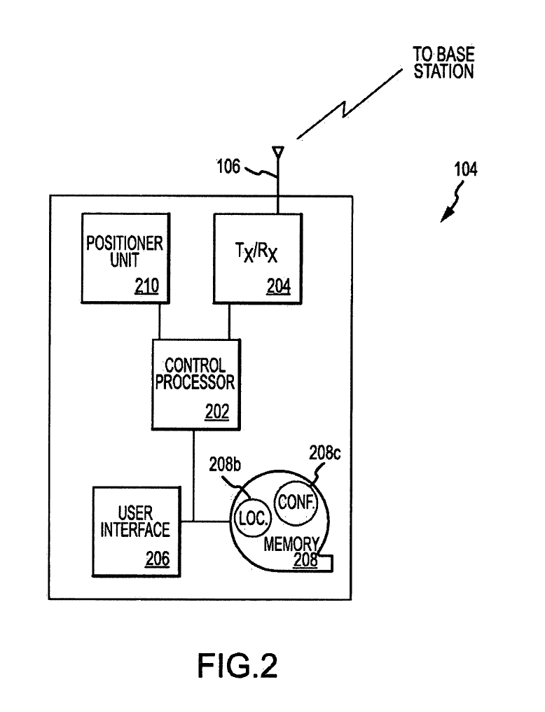

Referring now to FIG. 2, an exemplary embodiment of wireless device 104 is shown in more detail. wireless device 104 includes several components including a control processor 202. Control processor 202 controls the major functions of wireless device 104 including providing computing functionality to process the inputs and/or data required for the operation of wireless device 104. Transmit/receive circuitry 204 is connected to control processor 202 and antenna(s) 106. Transmit/receive circuitry 204 may be one or more actual circuits and may work over various protocols and wavelengths. Transmit/receive circuitry 204 functions typical of such components as used in wireless communications, such as modulating signals received from control processor 202 that are to be transmitted from antenna 106, and demodulating signals received at antenna 106 to be delivered to sent to control processor 202 or other components. Control processor 202 provides a means to configure applications and modes associated with wireless device 104. For example, control processor 202 controls the configuration of the wireless device volume or the like.

Wireless device 104 also includes a user interface 206. User interface may comprise a user interface typical of, for example, a cellular telephone or typical of the particular wireless device, such as, for example, a keyboard, an alphanumeric pad, a mouse, a track ball, a touch screen, a voice recognition, a microphone, speakers, data ports, or the like. The user 102 accesses, receives, and transmits information via user interface 206. The user interface 206 provides one means by which the control processor can be caused to initiate configuration of applications and modes, such as, for example, volume changes or the like.

Wireless device 104 includes a memory 208 connected to control processor 202. Memory 208 may store data and processing instructions necessary or convenient for operation of wireless device 104. Memory 208 may include volatile and/or nonvolatile memory on any suitable media. Memory 208 may include a configuration segment 208c. Configuration segment may store standardized or user defined configurations for wireless device 104 as will be explained further below.

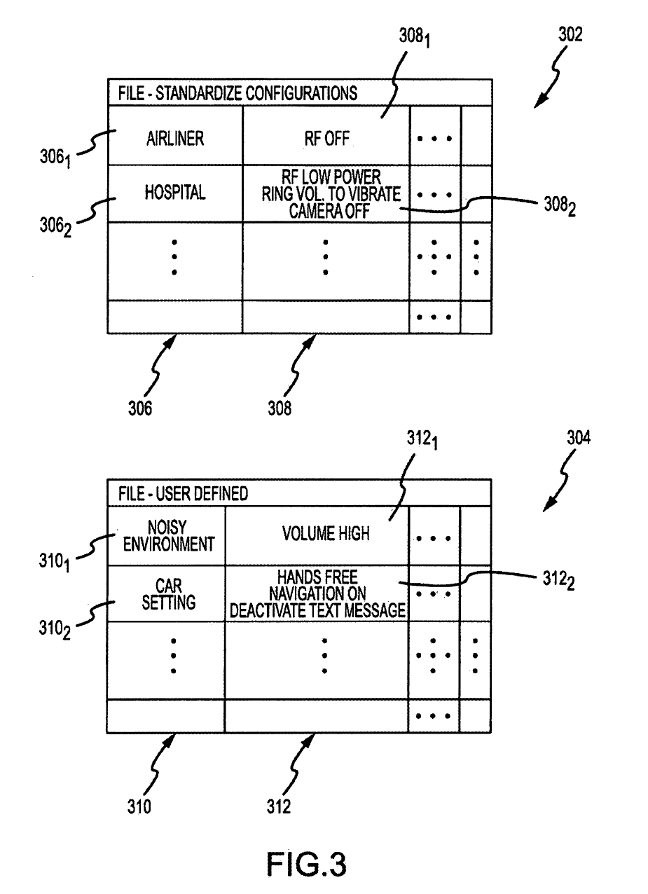

Referring to FIG. 3, configuration segment 208c of memory 208 is shown in more detail. Configuration segment is shown as a standard database spreadsheet, but any conventional memory structure is useable. As shown, configuration segment 208c may have multiple files, for example, file 302 may relate to standardized settings based on, for example, standards bodies. File 304 may relate to user defined setting generally based on expected usage or the like. File 302 may be broken down into a number of fields relating to standardized setting. One exemplary standardized setting may be airliner settings as shown in field 306₁. Field 308₁ may contain the standardized configuration for the setting, including, for example, RF transmitter/receiver Off, which is currently required by Federal Aviation Administration (FAA) standards. The configurations may sometimes be referred to as configuration information or instruction fields to be executed by the control process to configure the wireless device. Other application and mode configurations may be required by airliner setting and would be contained in field 308₁. Another exemplary standardized setting includes a hospital or medial setting as shown in field 306₂. Hospital or medical settings may be determined by the Food and Drug Administration (FDA) or the like). Field 308₂ associated with the setting would include specific configuration information for applications and modes for hospitals or the like, including, for example, RF transmitter to low power setting to reduce potential interference with medical equipment, ring volume to vibrate only, camera functionality off to provide patient privacy, etc. These are but two examples of potential standardized settings and configuration information, but any number of standardized configurations and settings may be provided as a matter of design choice.

Similarly, file 304 may comprise user defined setting. For example, the setting contained in field 310₁ may include a “noisy environment setting,” such as, for example, a machine shop or gym. In this setting, the configuration information or instruction field 312₁ may be arranged to configure the wireless device to high volumes, ring tone, microphone, and speakers, to facilitate use. Setting in field 310₂ may include “car setting.” Configuration information or instructions field 312₂ may contain instructions to configure the wireless device for hands free operation, activate a navigation module, and deactivate text messaging. These are but two examples of potential user defined configurations, but any number of user defined configurations and settings may be entered into configuration segment 208c of memory 208. Thus, if a user called up the car setting on the user interface, the control, processor would access the memory and extract and implement the configuration based on the configuration information tied to that setting. This avoids the need for the user to individually reprogram the individual applications or modes to the desired configuration.

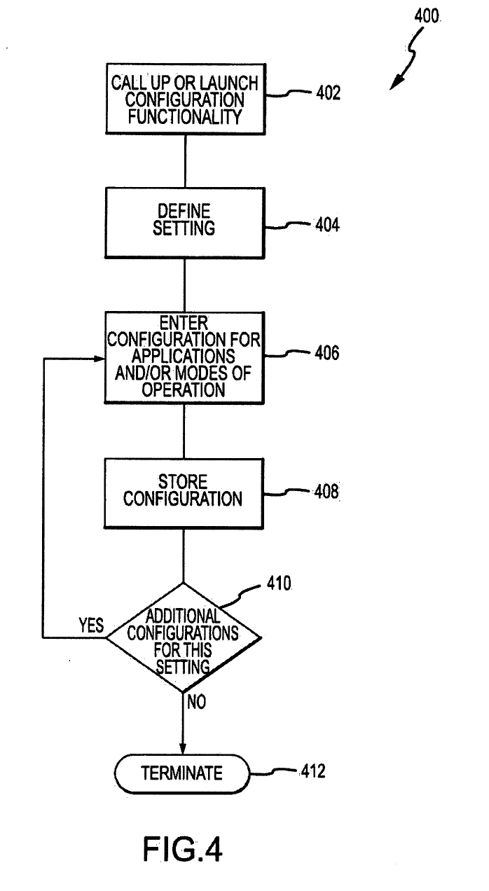

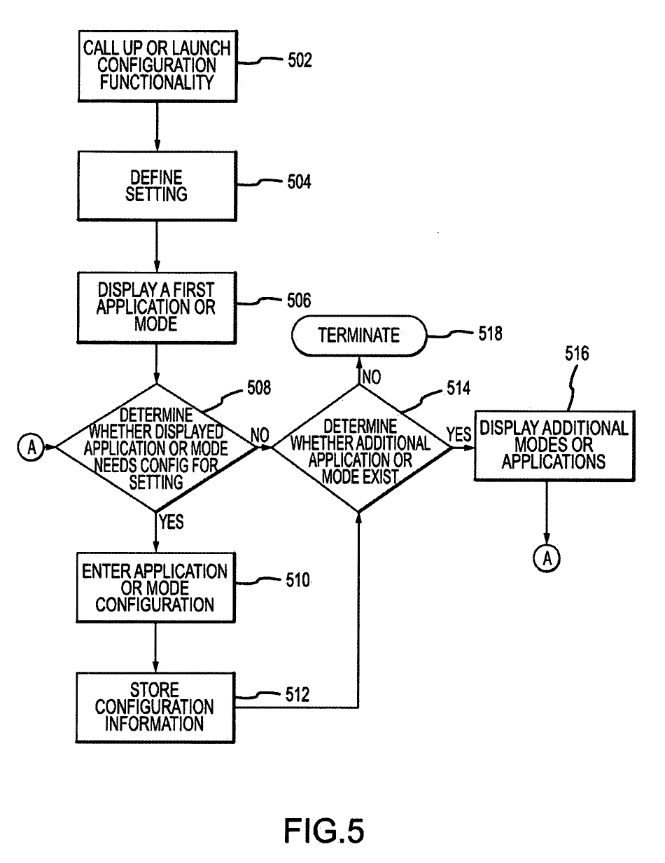

Referring now to FIG. 4, operational steps for providing a user defined setting and configuration information for wireless device 104 are described for an exemplary embodiment. First, user 102 accesses user interface 206 to call up the configuration functionality, step 402. Next, the user defines setting in field(s) 310₁₋ₙ, step 404. While it is envisioned that setting field 310 would define a particular usage, such as machine shop, car, theater, etc, the setting field 310 could be modes of operation, such as, for example, quiet, loud, traveling, etc. Moreover, its possible setting field(s) 310 could simply be numbers or designations, such as, setting 1, A, α, etc. In other words, designations for setting field(s) 310 are largely a matter of user preference. Next, the user would enter configuration information via the user interface 206, step 406. Possible configuration information include, for example, modes of operation, such as for example, volume, display lighting, and applications, such as, for example, navigation (a.k.a. GPS) settings, camera settings, internet settings, or the like. Control processor 202 would cause the configuration information to be stored in an appropriate field 312₁₋ₙ, step 408. Next, it would be determined whether additional configuration information was required for the setting field 310, step 410. For example, a display may be provided to the user requesting whether additional configurations are required or desired. If the user answers, yes (i.e., additional configurations are required or desired), control reverts to step 406 where the user would enter additional configuration information. If the answer is no, the process terminates, step 412. Referring to FIG. 5, alternative operational steps for providing user defined settings for wireless device 104 is described for an exemplary embodiment. First, user 102 accesses user interface 206 to call up the configuration functionality, step 502. Next, the user defines setting field(s) 310₁₋ₙ, step 504. Control processor then displays an application or mode to a user on user interface 206, step 506. The user than determines whether the displayed application or mode is required to be configured for the particular setting, step 508. If it is determined that the application or mode is required to be configured, the user enters the configuration information desired, step 510, which is stored, step 512. After the configuration is entered or if it is determined that the particular application does not need to be configured for the particular setting, it next is determined whether additional applications or modes exist, step 514. If additional applications or modes exist, that application or mode is displayed, step 516, and control reverts to step 508. If it is determined that additional applications or modes do not exist, the process ends, step 518, and the setting field 310₁₋ₙ with associated configuration information field 312₁₋ₙ are stored as a user defined setting that can be initiated by the user. Operational steps of FIG. 4 and FIG. 5 could, of course, be combined into a single operate. Moreover, the steps outlined in FIGS. 4 and 5 are exemplary and more, less, or different steps are contemplated, and the steps may be interchanged or re-arranged.

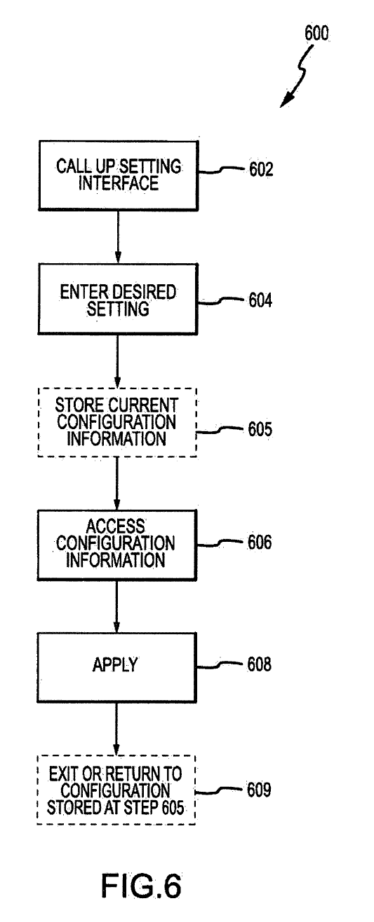

Referring now to FIG. 6, operational steps for manually activating or launching a programmed setting are provided in an exemplary embodiment. First, a user would user interface 206 to call up a setting interface, step 602. Next, the user would identify or enter the desired setting field(s) 310₁₋ₙ, step 604. Alternatively, the control processor could automatically identify the desired setting field. Control processor would access configuration information in corresponding field(s) 312₁₋ₙ, step 606, and apply the settings, step 608. Optionally, prior to re-configuring wireless device 104, at step 605, control processor may store existing settings and configurations of the wireless device. Thus, when the user exits the user defined setting, the wireless device can be returned to the previous configuration. Using conventional methodologies, the functionality activating a programmed setting may be assigned to a hotkey or speed dial key to facilitate the user 102 entering the desired configuration.

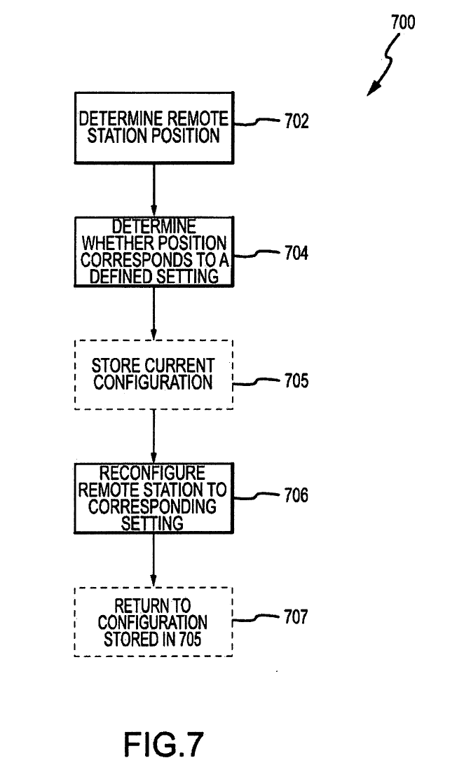

Referring back to FIG. 2, wireless device 104 may have a positioner unit 210, such as, for example, a global positioning unit or the like as those units are commonly used in the art. Positioner unit 210 may access a location unit 2081, which may be a database stored in memory 208 and/or remotely accessible via server 118. Positioner unit 210 may interact with location unit 2081 and setting fields 306 and 310 to automatically place wireless device 104 in a standard or user defined setting. In other words, positioner unit 210 and location unit 2081 may cause control processor 202 to configure wireless device 104 automatically. For example, user 102 may provide user defined setting field 310ₓ as a movie theater setting, for example. In movie theater setting, wireless device may have defined configuration information or instruction field 312_{y} of, for example, ring tone—to vibrate, display lighting—to brightest, speaker—to low, etc. As shown by FIG. 7, which provides operational steps for automatically activating a programmed setting for an exemplary embodiment, positioner unit 210 determines a position of wireless device 104, step 702. Location unit 2081 determines whether the location corresponds to a defined setting field(s) 306 or 310, step 704. In this example, the user may enter a movie theater, which is a known location in location unit 2081. If a location correspondence is determined, control processor 202 configures wireless device 104 based on the stored requirements, step 706. Optionally, the original configuration settings may be stored step 705 and the original configuration settings restored on leaving the movie theater, step 707. Of course the positioning and locating functions, as well as the setting and configuration storage may occur locally at wireless device 104 or they may be accessed remotely at server 118.

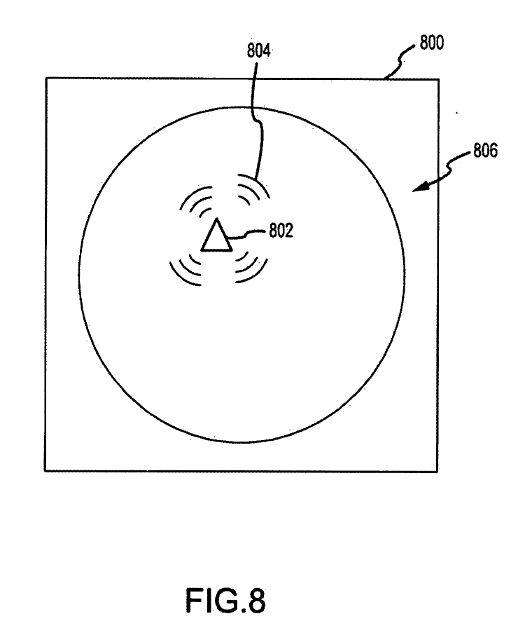

Certain locations, such as, for example, hospitals that have predefined settings may be configured as indicated above. Alternatively, as shown in FIG. 8, a location 800 may have a transmitter 802 that broadcasts a configuration signal 804 in a defined area 806. Wireless device 104 entering the defined area 806 would receive the configuration signal 804 at antenna 106. Transmit and receive circuitry would provide a usable signal to control processor 202, which would configure wireless device in accordance with standard predefined setting fields 306 configuration information or instruction field(s) 308.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless device comprising:
a user interface;
a control processor,
transmit and receive circuitry coupled to the control processor; and
a memory, the memory comprises at least a configuration segment that contains at least one user defined setting containing configuration information for the wireless device, such that
a user uses the user interface to transmit the at least one user defined setting to the control processor, the control processor uses the at least one user defined setting to access the configuration segment and configure the wireless device using the configuration information contained in the user defined setting.

2. The wireless device according to claim 1, wherein the configuration segment further comprises at least one predefined setting containing standardized configuration information.

3. The wireless device according to claim 2, wherein the predefined settings correspond to at least one of federal aviation administration requirements associated with airliners or food and drug administration requirements associated with hospitals.

4. The wireless device according to claim 1, wherein the configuration information includes at least one application configuration.

5. The wireless device according to claim 1, wherein the configuration information includes at least one mode configuration.

6. The wireless device according to claim 4, wherein the configuration information includes at least one mode configuration.

7. The wireless device according to claim 5, wherein the at least one mode configuration is selected from the group of modes consisting of: wireless device ring setting, wireless device volume, wireless device display brightness, or wireless device ring tone.

8. The wireless device according to claim 2, wherein the wireless device accesses a positioning unit to determine a position of the wireless device and a locating unit to determine whether the position of the wireless device corresponds to either the at least one user defined setting or the at least one predefined setting and causes the control processor to configure the wireless device.

9. The wireless device according to claim 8, wherein at least one of the positioning unit or the locating unit are accessed through a networked connection.

10. The wireless device according to claim 8, wherein at least one of the positioning unit or the locating unit are integrated into the wireless device.

11. A wireless device comprising:
a control processor for configuring at least one application or at least one mode of the wireless device;
a memory for storing at least one user defined setting containing configuration information for the at least one application or the at least one mode; and
a user interface for allowing a user to enter a setting, such that the control processor accesses the memory associated with the entered setting and configures the wireless device based on the configuration information associated with the at least one user defined setting.

12. A method for recording a user defined setting in a wireless device comprising:
launching a configuration entering program on the wireless device to allow a user to define a setting and enter configuration information;
defining a setting as the user defined setting;
entering configuration information by a user for at least one application or mode of the wireless device; and
storing the entered configuration information associated with the user defined setting.

13. The method according to claim 12, further comprising determining whether additional configuration information for the user defined setting is required and repeating the entering and storing steps until it is determined that additional configuration information is not required.

14. The method according to claim 12, wherein entering by the user configuration information for at least one application or mode of the wireless device further comprises:
displaying on the user interface at least one application or mode of the wireless device;
determining whether the displayed at least one application or mode of the wireless device requires configuration information to be entered for the user defined setting; and
inputting configuration information for the displayed at least one application or mode.

15. The method according to claim 15, wherein further comprising the step of repeating the displaying, determining, and inputting steps for all applications and modes of the wireless device.

16. A method of configuring a wireless device to user defined settings comprising:
launching a configuration application at the wireless device;
identifying a user defined setting stored in memory to which the wireless device will be configured;
retrieving configuration information relating to at least one application or at least one mode of the wireless device from memory; and
configuring the wireless device based on the configuration information retrieved relating to the at least one application or the at least one mode.

17. The method according to claim 17, wherein identifying the user defined setting comprises manually entering the user defined setting using a user interface on the wireless device.

18. The method according to claim 17, wherein identifying the user defined setting comprises establishing a position of the wireless device and determining a location based on the position and providing the location as the user defined setting if the location corresponds at least one use defined setting.

19. The method according to claim 19, wherein establishing a position and determining a location are performed remote from the wireless device.

20. The method according to claim 17, wherein including establishing a hotkey to cause the launching, identifying, retrieving, and configuring steps.

21. A computer readable media embodying a method for recording, a user defined setting in a wireless device, the method comprising:
launching a configuration entering program on the wireless device to provide an interface display allowing a user to define a setting and enter configuration information;
defining a setting as the user defined setting;
entering configuration information by a user for at least one application or mode of the wireless device; and
storing the entered configuration information associated with the user defined setting in a memory associated with the wireless device.

22. A wireless device comprising:
a user interface;
means for storing user defined setting containing configuration information to for configuration of at least one application or at least one mode;
means for configuring the wireless device apparatus based on the configuration information; and
means for initiating the means for configuration.

23. A method for automatically configuring a wireless device comprising:
storing predefined settings for the wireless device having configuration information for at least one application or at least one mode such that at least one of the predefined settings is based on a location designation;
determining a position of the wireless device;
determining whether the determined position of the wireless device corresponds to the location designation; and
if the determined position of the wireless device corresponds to the location designation, configuring the wireless device using at least one application or at least one mode of the wireless device based on configuration information associated with the predefined setting.

24. The method according to claim 24, wherein the predefined settings comprise user defined settings.

25. The method according to claim 24, wherein the predefined settings correspond to regulatory standards.

26. The method according to claim 26, wherein the regulatory standards are selected from the group of regulatory standards consisting of: federal aviation administration standards or food and drug administration standards.
